(19) United States
(12) Patent Application Publication
(10) Pub. No.: US 2003/0027965 A1
(43) Pub. Date: Feb. 6, 2003

(54) Polymer gels and methods for their preparation

(76) Inventors: David Henry Solomon, Officer (AU); Greg GuangHua Qiao, Doncaster East (AU); Georgia Patras, Ascot Vale (AU)

Correspondence Address: James D. Jacobs, Esq., Baker & McKenzie, 805 Third Avenue, New York, NY, 10022, US

(21) Appl. No.: 10/024,114

(22) Filed: Dec. 18, 2001

(30) Foreign Application Priority Data
Dec. 19, 2000 (AU) PR2180

(51) Int. Cl. C08F 120/54

(52) U.S. Cl. 526/303.1; 526/319

(57) ABSTRACT

The present invention is directed to a crosslinked polymer system comprised of at least one monomer having at least one double bond and at least one crosslinker having a plurality of functional groups, wherein the functional groups have a greater reactivity than the monomer. The present invention is also directed to a method of forming such a crosslinked polymer system.

### BACKGROUND OF THE INVENTION

The present invention relates to crosslinked polymer gels, methods for their preparation and articles made or formed from the gels.

Three-dimensional aqueous gels (hydrogels) are covalently crosslinked hydrophilic polymers that are insoluble in water. However, these gel networks establish equilibrium with the liquid and temperature of their surroundings for shape and mechanical strength. Variations in the concentration, structure and/or functionality of the monomer and/or crosslinker used in such gels can change the gel structure, and this is reflected, for example, in the porosity of the network.

Conventionally, crosslinked polymer structures are produced by using a crosslinking agent in which the double bond has approximately the same as, or as close as possible to, the reactivity of the monomer used to form the linear part of the polymer. For example, a crosslinked polystyrene polymer is usually formed by the monomer styrene and the crosslinker divinylbenzene (DVB), where the reactivity of the double bond of DVB is approximately the same as styrene.

Generally the reactivity ratio (r) of two different monomers is defined as the reactivity of the radical from the first monomer reacting with the first monomer over the reactivity of the radical reacting with the second monomer:

Reactivity Ratio r₁=K₁₁/K₁₂

Similarly,

Reactivity Ratio r₂=K₂₂/K₂₁

Here K₁₁ is the reaction rate of the radical from the first monomer reacting with the first monomer and K₁₂ is the radical from the first monomer reacting with the second monomer.

Thus, the conventional approach used to form a crosslinked gel is by choosing similar reactivity ratio r₁ and r₂. When r₁=r₂=1, during the network formation, the crosslinker enters the polymer chain in a statistical manner depending on the concentration. For an ideal system, if there is one crosslinker for every 10 monomers, the polymer network incorporates a crosslinker unit for every 10 units of the monomer.

The present inventors have discovered that crosslinkers that contain two slightly different reactive functional groups. The functional group reactivity was a combination of two of the following groups: acrylamide, methacrylamide, acrylate and methacrylate. The resultant gels were found to have enhanced protein separation in electrophoresis that has been attributed to the reactivity differences between the monomers.

These crosslinkers were used in an effort to control the network by delaying the reaction of one of the double bonds by selecting a crosslinker in which one of the double bonds has the same reactivity as the monomer forming the linear part of the chain and the other is less reactive. These crosslinkers contain only two double bonds, and were designed to control the exotherm by delaying the reaction of the second double bond. This delayed reaction results in polymers that are less crosslinked in the earlier stage of the polymerization. Therefore, the formed polymer with pending second double bond on its chain still has mobility and termination of the radical reaction continues and two chains can self annihilate (termination by combination or disproportionation), resulting in a controlled exotherm of the reaction. This occurs because in a free radical polymerization, a stage is reached where self-termination is prevented. This stage is influenced by the viscosity, and is called the gel-effect. At this point in the polymerization, self-termination is prevented, the chains cannot approach one another and the rate of monomer conversion is greatly increased with a consequently large exotherm.

Although many different gels have been formed, there is still a need for new gels for industrial, scientific and medical applications.

### SUMMARY OF THE INVENTION

The present inventors have made the surprising discovery that by using a crosslinker that has at least two double bonds with a greater reactivity than the monomer used to form the linear polymer, a polymer network (or gel) with unexpected but useful properties results. For example, a crosslinked polymer gel with an exceptionally high concentration of monomer and crosslinker (high T % and C %) was formed where the optical clarity of the gel is still relatively high. In addition the same crosslinked system can result in a polymer network with larger pores and enhanced sieving properties during electrophoresis.

It is proposed that these gel properties arise because the double bond of the crosslinking agent is more reactive than the double bond of the monomer, and enters the polymer chain more readily than the monomers resulting in a new pathway of polymer network formation. It is believed this new pathway is controlled by the reactivity of the crosslinker, which influences the manner in which the network forms, by controlling the composition of the initially formed polymer. The manner in which the network forms is evident by the exotherm generated when two crosslinkers, with similar and variable double bond reactivity, are compared (FIG. 1). For example N,N-methylenebisacrylamide (BIS) has acrylamide type reactivity and the similarly shaped crosslinker N,N-methylenebismethacrylamide (mBIS) has the more reactive methacrylamide type double bonds compared to acrylamide. From the existing gelation theory it was expected that the crosslinker with methacrylamide type reactivity such as mBIS to generate a relative large exotherm very quickly. However, the opposite was observed and the methacrylamide type crosslinkers, such as mBIS, produced a depressed exotherm during the free radical polymerization with the acrylamide monomer. This has lead the present inventors to believe that a heterogenous micro-phase structure is formed during the polymerization when the reactivity of the crosslinker is greater than that of the monomer's. The microphase structure, which can also be called a star type structure, contains better chain mobility throughout the polymerization period,behaves essentially like a linear polymer, and does not give the expected exotherm.

In accordance with the present invention, there is provided a crosslinked polymer system comprised of at least one monomer having at least one double bond and at least one crosslinker having a plurality of functional groups, wherein the functional groups have a greater reactivity than the monomer.

Further, in accordance with the present invention, there is provided an article comprised of a crosslinked polymer system, the crosslinked polymer system comprising at least one monomer having at least one double bond and at least one crosslinker having a plurality of functional groups, wherein the functional groups have a greater reactivity than the monomer.

Still further, in accordance with the present invention, there is provided a method for forming a crosslinked polymer system comprising the steps of:

preparing a crosslinker solution comprised of at least one crosslinker;

preparing a monomer solution comprised of at least one monomer; wherein the at least one crosslinker in the crosslinker solution must have a greater reactivity then the at least one monomer in the monomer solution;

mixing the crosslinker solution and the monomer solution together to form a crosslinker/monomer solution;

preparing an initiator solution comprised of a polymerization initiating material which initiates polymerization of the crosslinker/monomer solution;

mixing the crosslinker/monomer solution and the initiator solution together to form an initiated solution; and

allowing the initiated solution is allowed to polymerize to form the crosslinked polymer system.

The following abbreviations are used throughout the specification: Acrylamide (AAm), N,N′-methylenebisacrylamide (BIS), polyacrylamide gel electrophoresis (PAGE), Scanning electron microscopy (SEM), N,N′-methylenebismethacrylamide (mBIS), hydroxyl ethyl acrylate (HEA), ethylene glycol diacrylate (EGDA), hydroxyl ethyl methacrylate (HEMA), ethylene glycol dimethacrylate (EGDMA).

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

In order that the present invention may be more clearly understood, preferred forms will be described with reference to the following drawings and non-limiting examples.

### BRIEF DESCRIPTION OF DRAWINGS

FIG. 1 is a schematic diagram showing the molecular structure of crosslinkers used to make polyacrylamide gels and membranes described below;

FIG. 2 shows the temperature profile over time during the free radical polymerization of AAm with different crosslinkers;

FIG. 3 shows the amount of water swelling changes at 120 min with the change of T % of a polyacrylamide gel crosslinked by either BIS or mBIS under constant 3 C %;

FIG. 4 shows the amount of water swelling changes at 120 min with the change of T % of a polyacrylamide gel crosslinked by either BIS or mBIS under constant 7 C %;

FIGS. 5a and 5b are Ferguson plots and the migration patterns obtained for the polyacrylamide gels containing different crosslinkers after fractionation by PAGE of a broad range protein standard;

FIGS. 5c and 5d show the Rf difference for a broad range protein standard after PAGE with polyacrylamide gels containing multifunctional crosslinkers compared to the BIS crosslinked polyacrylamide gels;

FIG. 6 shows the difference of Rf value obtained from protein electrophoresis between the gel crosslinked with mBIS and BIS under the formulation of 15T %/3C %;

FIG. 7 shows the difference of Rf value obtained from protein electrophoresis between the gel crosslinked with mBIS and BIS under the formulation of 30T %/3C %;

FIG. 8 shows the difference of Rf value obtained from protein electrophoresis between the gel crosslinked with mBIS and BIS under the formulation of 15T %/7C % and 5T %/7C %;

FIG. 9 shows the difference of Rf value obtained from protein electrophoresis between the gel crosslinked with mBIS and BIS under the formulation of 10T %/5C %;

FIG. 10 shows the difference of Rf value obtained from protein electrophoresis between the gel crosslinked with mBIS and BIS under the formulation of 20T %/5C %

FIGS. 11a and 11b show SEM images obtained for 10% T 3% C polyacrylamide gels crosslinked with BIS, 1a and 1b; and

FIGS. 12a and 12b show clarity comparisons between HEMA/EGDMA and HEA/EGDMA gels.

### DETAILED DESCRIPTION OF THE INVENTION

The present invention is directed to a crosslinked polymer system comprised of at least one monomer having at least one double bond and at least one crosslinker having a plurality of functional groups, wherein the functional groups have a greater reactivity than the monomer.

Preferably the reactivity ratio (r) of the at least one crosslinker to the at least one monomer for r₁ is in the range of about 0.001 to about 0.8 and for r₂ is in the range of about 1 to about 6. More preferably, the reactivity ratio (r) of the at least one crosslinker to the at least one monomer for r₁ is in the range of about 0.05 to about 0.1; and for r₂ is in the range of about 1.3 to about 4.

Preferably the % T of the polymer system is in the range of about 5% T to about 40% T and the % C of the polymer system is in the range of about 3% C to about 15% C. These values are largely dependent on the specific application. The accepted terminology of % T refers to the total concentration of the monomer and the crosslinker as a percentage (w/v). The term % C refers to the concentration of the crosslinker (w/w) as a portion of % T.

The functional groups of the at least one crosslinker used are suitably the same or different, where at least two or more of the functional groups are more reactive than the double bonds of the acrylamide monomer. The crosslinker is suitably a linear, branched or cyclic compound. Preferably all functional groups of the crosslinker have an ethylenic double bond. Particularly preferred crosslinkers are those described in Applicant's International Application No. PCT/AU00/00238, the disclosure of which is incorporated herein by reference.

The crosslinkers used are suitably the mixture of at least two types of crosslinkers, including the conventionally used crosslinker with the same reactivity. The mixed system is suitably used to provide both properties of the traditional gel structure and new polymer network in accordance with the present invention. For the maximum effect, the double bond with the lowest reactivity from the crosslinkers should be higher than the highest reactivity of the monomers.

The monomer or monomers used are suitably any suitable monomer known in the art. In one embodiment, the gel may be formed from at least two different monomers.

The polymer system is suitably prepared from at least one monomer having the formula H₂C═CR₅—CO—N(R₃)R₄ where R₃, R₄ are each selected from the group consisting of H, alkyl, alcohol (—(CH₂)ₙ—OH), and ester (—(CH₂)ₙ—OCH₃), where n is an integer from 1 to 6, and R₅ is selected from the group consisting of H and substituted alkyl. Examples of monomers include, but are not limited to, acrylamide, acrylamide derivatives or acrylamide substitutes known to the art, such as N,N-dimethylacrylamide, methacrylamide, N-methyloylacrylamide, propylacrylamide, dipropyl acrylamide, isopropyl acrylamide, diisopropyl acrylamide, lactyl acrylamide, methoxyacrylamide and mixtures thereof.

In one embodiment, the polymer system is suitably formed from a monomer system of acrylamide (AAm) with methylenebismethylacrylamide (mBIS) or other crosslinker which has greater reactivity than AAm, such as 2-hydroxyethyl methacrylate.

In another embodiment, the polymer system is formed from non-acrylamide type monomers such as ester type systems. An example of such system would be hydroxyethyl acrylate (HEA) as the monomer with the more reactive ethyleneglycol dimethacrylate (EGDMA) as the crosslinker or combined with other crosslinkers. Other suitable monomer/crosslinker systems are shown as follows:

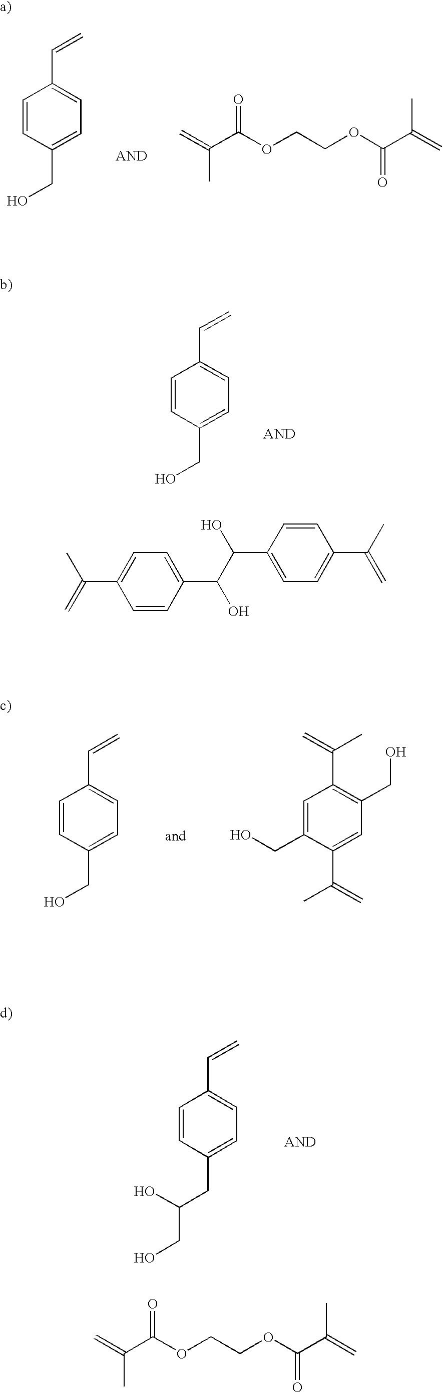

In one embodiment, the crosslinked polymer system is a hydrogel. In a preferred embodiment, the hydrogel has a hetero microphase structure. By the term “hetero microphase structure” is meant a gel network that is characterized by a plurality of highly crosslinked loci or cores interconnected by relatively linear polymer chains. Particularly preferred are those monomers used to produce hydrogel intraocular lenses and biological separation matrices and the like.

Due to the nature of this new polymer system of the present invention, it is possible to produce higher crosslinked gels with high optical clarity that is not producible with conventional methods. This property is particular useful in the lens industry where manufacturing harder and clearer lens is desirable.

Furthermore, by applying this new technology, it is also possible to produce a polymer network with large pore sizes that cannot be obtained using the conventional method due to the low concentration of the crosslinking points. This is particularly useful in membrane applications for the separation of large molecules in electrophoresis.

In another embodiment, the present invention is directed to an article at least in part from a crosslinked polymer system comprised of at least one monomer having at least one double bond and at least one crosslinker having a plurality of functional groups, wherein the functional groups have a greater reactivity than the monomer. In one embodiment, the article is an optical lens, such as a contact lens.

In another embodiment, the article is an electrophoresis gel. In one embodiment, the electrophoresis gel does not have a gradient. In another embodiment, the electrophoresis gel has a gradient wherein such gradient is suitably a porosity gradient, composition gradient or concentration gradient. The gradient is suitably achieved by using different concentrations of the polymer gel or by altering the ratio of crosslinker to monomer.

In one embodiment, the electrophoresis gel has a porosity gradient suitable for gradient gel electrophoresis. See for example, Polyacrylamide Gel Electrophoresis across a Molecular Sieve Gradient Margolis, J., Kenrick, K. G., Nature, 214, 1967, p1334-1336; Polyacrylamide Gel Electrophoresis in a Continuous Molecular Sieve Gradient, Margolis, J., Kenrick, K. G., Analytical biochemistry, 25, 1968, p347-362; and Practical System for Polyacrylamide Gradient Gel electrophoresis, Margolis, J., Laboratory Practice, 22, p107-109, 1973, the disclosures of which are incorporated herein by reference.

In one embodiment, the article is in the form of a membrane. Preferably, the membrane is formed on a porous substrate. The substrate supplies the support frame for the electrophoretic medium. The substrate may be a porous paper or fabric or the substrate may be a woven or non-woven sheet, for example, a non-woven PET.

The greater control on designing gels with a different pore size range and/or distribution provided by the polymer gels of the present invention make them particularly suitable for use in electrophoresis separation method and apparatus. This technology is incorporated into Gradipore Limited's Gradiflow™ technology. The technology allows for the separation of macromolecules such as proteins, nucleotides and complex sugars. This technology can be used for size separation, concentration and dialysis. A commercially available form of this technology is Gradipore Limited's Gradiflow™ BF200 unit. The Gradiflow ™ technology is comprised of a membrane cartridge, which consists of three or more polyacrylamide-based membranes. Outer membranes can be small pore size restriction membranes that prevent the movement of larger compounds and allow the movement of small ions. The inner membrane(s) is the separating membrane, which varies with the particular application. This inner membrane usually has a larger, but defined pore size. It is in this inner membrane that the membrane of the present invention has particular application. For specific applications, the membrane may be charged or have an affinity ligand embedded within the membrane.

By applying mixed monomers containing a charged group, together with the crosslinker with great reactivity, the present invention can produce a polymer network with porosity controlled by external stimuli.

The above described pore size of the polymer network with diallable porosity can be controlled by, for example, the pH of the solution or the voltage applied on the polymer during its electrophoresis.

By applying mixed monomers containing part of the monomer with specific conformation, together with the crosslinker with great reactivity, the present invention can produce a polymer network with diallable porosity by changing this specific conformation.

The above described pore size of the polymer network with diallable porosity can be controlled by using specific wavelength under photolysis to switch the conformation in one way or the other.

The present invention also provides a method for forming a crosslinked polymer system. The method comprises preparing a crosslinker solution containing at least one crosslinker and preparing a monomer solution containing at least one monomer. The crosslinker must have a greater reactivity then the at least one monomer. The crosslinker solution and the monomer solution are then mixed together to form a crosslinker/monomer solution. Preferably, the crosslinker/monomer solution is treated to substantially remove any oxygen or other undesired components. An initiator solution comprised of a polymerization initiating material which initiates polymerization of the crosslinker/monomer solution is prepared. The crosslinker/monomer solution and the initiator solution are mixed together to form an initiated solution and the initiated solution is allowed to polymerize to form the crosslinked polymer system.

In order that the present invention may be more clearly understood, examples of crosslinked polymer system are described with reference to the preferred forms of the separation technology as described.

### EXAMPLES

### General Procedure for Preparing Polyacrylamide Gels

### Example 1

### Synthesis of the Crosslinkers

1,3,5-triacrylylperhydro-s-triazine (1a) [Emmons, W. D., Rolewicz, H. A., Cannon, W. N., Ross, R. M., J. Am. Chem. Soc. 1952, 74, 5524-5525] and 1,3,5-trimethacrylylperhydro-s-triazine (1b) [Gresham, T. L., Steadman, T. R., J. Am. Chem. Soc. 1949, 71, 1872] were synthesized as previously reported. The monomers Bis and mBis were of electrophoresis grade and used without further purification. The monomers were recrystallized from alcohol and employed after purification was confirmed. Monomers 2a-5b were prepared, as recently reported [Patras, G., Qiao, g., Solomon, D. H., PCT/AU00/00238, 2000].

### Example 2

### Preparation of the Stock Monomer Solution

A 30% T 3% C stock solution is made up by dissolving acrylamide (29.10 g) with the selected crosslinker either Bis (0.90 g), mBis (1.06 g), 1a (0.97 g), 1b (1.13 g), 2a (1.20), 2b (1.36), 3a (1.03 g), 3b (1.20 g), 4a (1.06 g), 4b (1.22 g), 5a (1.28 g), or 5b (1.45) in a 100 mL volumetric flask with distilled water. The solution was filtered through a Whatman No. 1 filter paper and stored at 4° C. prior to use. A 40% T 10% C stock solution was similarly made with AAm (36.0 g) and the selected crosslinker Bis (4.0 g), mBis (4.73 g) in a 100 mL volumetric flask with distilled water. Dissolving AAm (40 g) in a 100 mL volumetric flask made a 40% T 0% C stock solution.

### Example 3

### Preparation of the Polyacrylamide Gels

For all crosslinking agents with different potential functionality (different number of polymerizable groups), substitutions were calculated on a mole basis (not on a weight basis) with Bis. When the potential functionality varied between the crosslinkers, the substitutions were calculated on an equivalent number of double bond basis with Bis. For an AAm and Bis system the accepted terminology of % T refers to the total concentration of the monomer AAm and the crosslinker Bis as a percentage (w/v). The term % C refers to the concentration of the crosslinker Bis (w/w) as a portion of % T. The crosslinkers used with a potential functionality greater than four were calculated on an equivalent basis where the number of double bonds initially in the solution are the same. That is, for every 1 mole of Bis, ⅔ of a mole of a hexafunctional crosslinker was required. This formulation will result in the real value of % T and % C of each PAAm gel crosslinked with a crosslinker other than Bis to vary from the Bis crosslinked AAm system. For example a 10% T 3% C gel would contain 9.7 g of AAm and 0.3 g of Bis per 100 mL. An equivalent 10% T 3% C solution containing the hexafunctional crosslinker 1a would require 9.7 g of AAm and 0.32 g of the crosslinker 1a. This results in an actual concentration of 10.02% T 3.19% C for the AAm and 1a system. For simplicity, the concentrations used refer to Bis crosslinked gels, and all the other crosslinked systems with similar concentrations are referred to as the equivalent Bis % T and % C concentration.

A polyacrylamide gel solution (10 mL) was prepared by mixing the required amounts of the appropriate stock monomer solution (3.33 mL), distilled water (4.17 mL) and 1.5 M Tris-HCl buffer (pH 8.8) (2.5 mL). The 1.5M Tris-HCl buffer was made by dissolving Tris (27.23 g) in water (80 mL), adjusting the pH to 8.8 with 6N HCl, and diluting to 150 mL with distilled water. The polyacrylamide gel solution was degassed by vacuum aspiration at room temperature for 40 minutes and then purged with nitrogen until the initiator system was added. The initiator system was composed of freshly made up 10% (w/v) APS (0.025 mL) and 10% (v/v) TEMED (0.025 mL) where the mole ratio of APS to TEMED was kept constant at 1:1. The gel solution (7 mL) was immediately cast between two glass cassettes (8×8 cm, 1 mm apart) purging with nitrogen and left to polymerize for at least 3 hours.

### Example 4

### Conversion of Monomer and Crosslinker into Polyacrylamide Gels

The degree of copolymerization between AAm and a crosslinker towards a three-dimensional polymer network was measured using a HPLC system. The polyacrylamide gel was made as described in Example 3 was removed from the glass cassette, weighed, crushed in a beaker and washed with methanol three times to extract the unreacted residual acrylamide and crosslinker. The methanol washings were combined, filtered and made up to 50 mL in a volumetric flask. A 50 uL sample of this solution was injected into the HPLC with methanol as the eluant and with a detecting wavelength at 254 nm. This wavelength was chosen because all unreacted double bonds are detected and it reaches a good compromise between sensitivity and convenience. The peaks observed for the unchanged monomers were measured against an acrylamide standard curve to calculate the concentration and amount of unreacted double bonds.

### General Procedure for Analysis of Polyacrylamide Gels with Different Crosslinkers Compared to Bis

### Example 5

### Polymerization Temperature Profiles

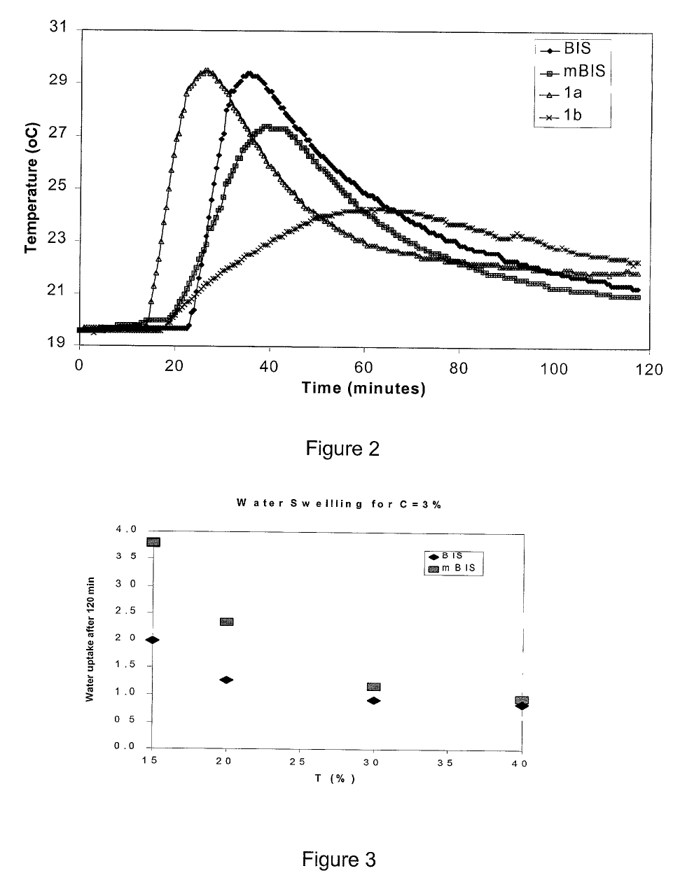

The monomer and crosslinker solution (4 mL) was prepared as described in Example 3 and cast into a small glass vial purged with nitrogen. The vial containing a thin temperature probe began to record the temperature as soon as the monomer solution was poured into the glass vials, initiated, and the glass vials were capped. The temperature probe readings were taken every 30 seconds for 2 hours and a temperature profile of the polymerization reaction was obtained. The results are shown in FIG. 2.

### Example 6

### Water Swelling

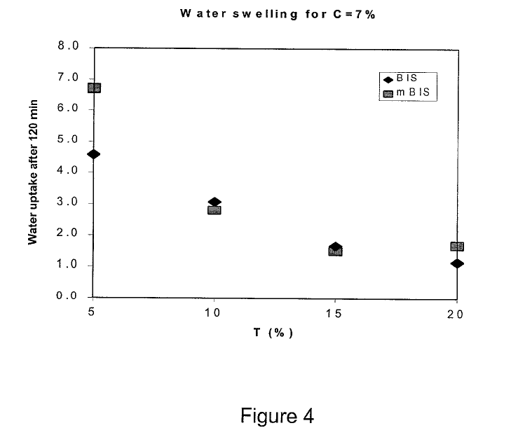

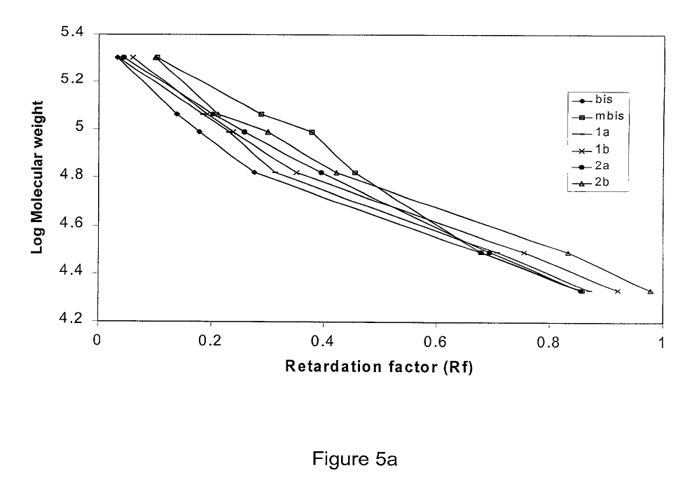

The amount of water absorbed and the degree of swelling of a polyacrylamide gel was measured. A piece of the polyacrylamide gel (5×5 cm) was made as described in Example 3 was cut, weighed and dried in a 60° C. oven for 24 hours. The dry gel was then weighed and immersed in 100 mL of distilled water, at 20° C. Every 10 minutes for 2 hours the gel was removed from the water, patted with filter paper to remove any excess surface water, weighed and returned to the water. The results are shown in FIGS. 3 and 4.

### Example 7

### Polyacrylamide Gel Electrophoresis (PAGE)

SDS-PAGE were performed and prepared under the discontinuous conditions of Laemmli [Laemmli, U. K., Nature 1970, 227, 680-685]. A stacking gel with a concentration of 5% T 3% C was similarly prepared as described in Example 3. The stacking gel (1-2 mL) was poured into the top of the glass cassettes already containing the resolving polyacrylamide gel made above to make the mold for the protein wells required for electrophoresis. SDS-PAGE was performed with a constant voltage of 150V and 500 mA for one hour using a constant power supply, a Gradipore Micrograd™ vertical electrophoresis unit and a TRIS electrophoresis running buffer. The TRIS buffer was prepared by dissolving Tris (9 g), SDS (3 g) and glycine (43.2 g) in 100 mL of distilled water and diluting 1:5 with distilled water before use. A 10 uL broad range protein marker was microsyringed into the sample wells embedded in the stacking gel and separated using Electrophoresis. The gels were stained after electrophoresis with a Coomassie brilliant blue G250 stain for 24 hours and then destained with 10% acetic acid to visualize the protein migration pattern.

### Example 8

### Scanning Electron Microscopy (SEM)

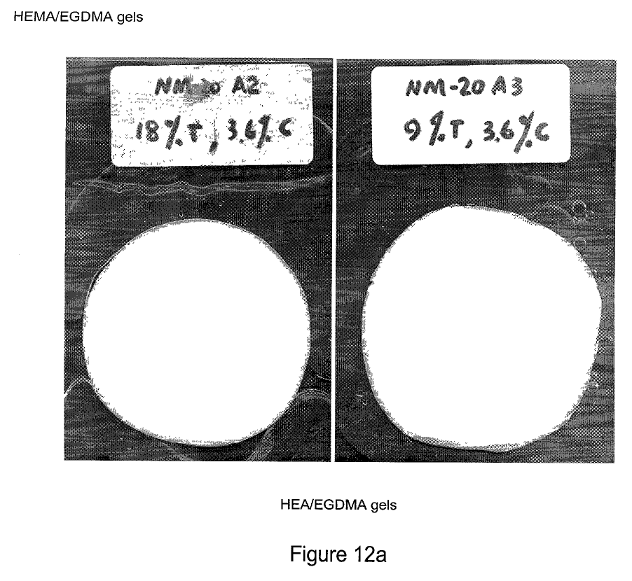

A piece of a polyacrylamide gel (5×5 cm) was made as described in Example 3 and mounted vertically on a SEM stub with a non-conductive glue and cryogenically fractured in liquid nitrogen. The water was sublimed at −95° C. for 90 minutes and then the sample was cooled to −198° C., coated with platinum using argon gas and plasma for 2 minutes. The images of the fractured polymer were then taken at various magnifications. The results are shown in FIGS. 11a and 11b.

### Gel Characterization Results of Polyacrylamide Gels

### Example 9

### Novel Multifunctional Crosslinkers

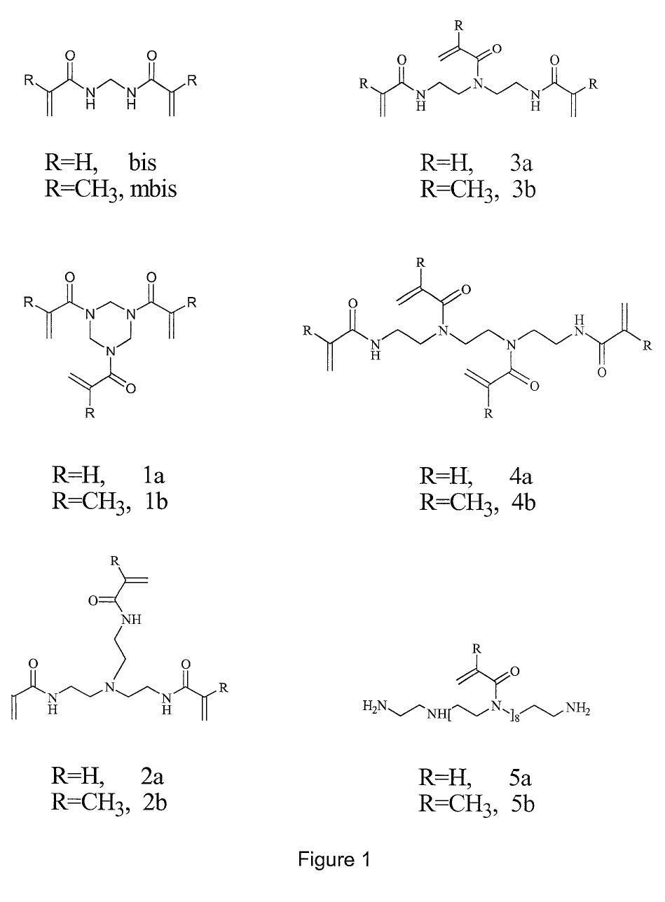

The structural design of the crosslinkers used for the formation of polyacrylamide gels is shown in FIG. 1. A systematic investigation to correlate the reactivity of the crosslinker with the properties of the polyacrylamide three-dimensional network was carried out. The double bonds of the crosslinkers were either of acrylamide type reactivity (Bis, 1a, 2a, 3a, 4a and 5a) or methacrylamide type reactivity (mBis, 1b, 2b, 3b, 4b and 5b) and all crosslinkers were soluble in aqueous AAm solutions. The relative monomer reactivity towards polyacrylamide radicals has been reported to be 1.00 for acrylamide and 1.35 for methacrylamide type double bonds.

### Example 10

### Polymerization Characterization

Initially, the extent of the polymerization or the degree of the monomer and crosslinker double bonds reacted were measured to ensure a reproducible three-dimensional network was formed, and the observations made were representative of the true gel network. All the gels tested had greater than 99% monomer conversion which were considered satisfactory for further analysis and applicable for bio separations.

The network formation of a free radical polymerization is a kinetically controlled process where the addition reaction of the monomer double bonds during the chain growth is exothermic. Measuring the temperature increase over time, this exothermic free radical polymerization can be monitored and provide a measure for the amount of AAm incorporated into the polymer network over time.

The change in temperature and the polymerization rates between the monomer acrylamide and a crosslinker is shown in Table 1. The curve obtained contains a flat line (induction period) at the beginning of the reaction, which is sensitive to inhibitors such as oxygen, which may delay the onset of the polymerization. This is followed by a sharp rise in temperature. The gradient of this rise is used to calculate the rate of the polymerization and the maximum change in temperature. The polymerization rate was slower and the ‘Trommsdorff’ effect was slightly depressed for PAAm gels crosslinked with the methacrylamide type crosslinkers compared to the equivalently structured acrylamide type crosslinkers.

TABLE 1
Temperature range and polymerization rates during the free radical
polymerization of acrylamide with different crosslinkers

| | Temperature | slope |
|---|---|---|
| Crosslinker | change | (° C./mins) |
| BIS | 11.2 | 0.559 |
| 1a | 10.6 | 0.499 |
| 2a | 9.5 | 0.389 |
| 3a | 11.1 | 0.540 |
| 4a | 8.2 | 0.261 |
| 5a | 6.2 | 0.260 |
| mbis | 9.0 | 0.278 |
| 1b | 3.7 | 0.083 |
| 2b | 6.9 | 0.166 |
| 3b | 1.3 | 0.008 |
| 4b | 1.7 | 0.008 |
| 5b | 3.0 | 0.024 |

### Example 11

### Polyacrylamide Gel Optical Clarity

At a concentration of 10% T 3% C 1a crosslinked gels were slightly cloudy upon the onset of the gel point despite being less reactive and more hydrophilic than 1b. Polyacrylamide gels crosslinked with 1b were clear at 10% T 3% C. This phase separation was attributed to the formation of a tightly packed network which exudes water from the three dimensional network. The 1a gels presumably forms a tight and rigid network with AAm, which the water (solvent) cannot penetrate to push the chains apart, and solvate the gels. However, the gel crosslinked with 1b had equivalent functionality to 1a, but was clear and transparent. This was also observed for the Bis and mBis system. Opaque gels were reported to form when the concentration was greater than 5% C for BIS crosslinked polyacrylamide gels. Comparisons of optical clarity between BIS and mBIS were made and the results are shown in Table 2 and Table 3. At concentrations below 5% C both BIS and mBIS were transparent even at 40% T. At 10% T 5% C BIS gels started going cloudy and at 10% T 7% C BIS had become opaque. mBIS were slightly cloudy at 10% T 7% C and were not completely opaque until a concentration of 10% T 20% C was reached. The difference in the hydrophilic and hydrophobic balance between BIS and mBIS or 1a and 1b does not appear to be a determining factor in this system. This phenomenon was related to the different pathways taken for the formation of the polymer network, which must be linked to the reactivity of the crosslinker.

The crosslinker mBis and 1b has more reactive methacrylamide double bonds than 1a, BIS and AAm. Generally, during the early stages of the polymerization the crosslinker mBis and 1b will be incorporated into the polymer chain much earlier than acrylamide resulting in loci of highly concentrated crosslinked areas. Once mBis or 1b is consumed into the polymer network, the remaining AAm in the solution will continue to react and build relatively linear polymer chains branching away from these crosslinked loci, linking them together and forming the resultant three-dimensional polymer network. During the elongation of the AAm polymer chains there is considerable flexibility and mobility within the reaction mixture to allow termination of the radicals present on the growing chains. Therefore, a smaller “Trommsdorff’ effect with mBis and 1b was observed compared to Bis and 1a respectively.

TABLE 2
Optical clarity of polyacrylamide gels crosslinked with BIS

| | | C | | | | | | | | |
|---|---|---|---|---|---|---|---|---|---|---|
| | BIS gels | 0.5 | 1 | 2 | 3 | 5 | 7 | 10 | 15 | 20 |
| T | 2.5 | | | | 0 | | | | | |
| | 5 | | | | 0 | 0 | 2 | | | |
| | 10 | 0 | 0 | 0 | 0 | 2 | 3 | 3 | 3 | 3 |
| | 40 | | | | 0 | | | | | |

TABLE 3
Optical clarity of polyacrylamide gels crosslinked with mBIS

| | | C | | | | | | | | |
|---|---|---|---|---|---|---|---|---|---|---|
| | mBIS gels | 0.5 | 1 | 2 | 3 | 5 | 7 | 10 | 15 | 20 |
| T | 2.5 | | | | | | | | | |
| | 5 | | | | | | 0 | | | |
| | 10 | | | | | 0 | 1 | 2 | 2 | 3 |
| | 15 | | | | 0 | 1 | 2 | | | |
| | 20 | | | | 0 | 1 | 3 | 3 | | |

0 represents a clear gel
1 represents a slightly cloudy gel
2 represents a cloudy gel
3 represents an opaque gel

Surprisingly the gels crosslinked with mBIS and 1b were clear and remained transparent at relatively high concentrations and their polymerization rate was slower and the ‘Trommsdorff’ effect was depressed compared to BIS and 1b gels respectively. The present inventors propose that mBIS and 1b have a core in which the crosslinker is concentrated and from which the relatively linear acrylamide arms grow. These particles appear to be approaching a microgel indicating a greater mobility of the chains compared to the case of BIS and 1a. That is, more self-termination is occurring. Microgels are ‘intramolecularly’ crosslinked macromolecules in solution of colloidal dimensions that are usually swollen and transparent. The microgels synthesized in these example are star-shaped macromolecules that contain small highly crosslinked loci of crosslinked polymer particles that have lots of long chains connecting them together. This type of polymer network results in microgels being completely solvated and resulting in a transparent gel regardless of the concentration of monomers and crosslinkers used. It is envisaged in the polyacrylamide network with mBIS and 1b as the crosslinker. The quick and initial incorporation of mBIS and 1b into the polymer creates a number of highly crosslinked loci which are small due to the low concentration of mBIS and 1b used compared to AAm. Once mBIS and 1b was consumed into the polymer network, AAm begins to react and build polymer chains branching away from these crosslinker loci and linking them together forming a three-dimensional polymer network. During the elongation of the acrylamide polymer chains there is still considerable mobility within the reaction mixture. This allows termination of the radicals present on the chains to take place. Therefore, a dramatic ‘Trommsdorff’ effect is not observed as seen in FIG. 2 by the shape of the mBIS and 1b curve since the gel will be solvated in water similar to that observed for microgels.

### Example 12

### Water Swelling Properties

The content and degree of swelling of polyacrylamide gels according to the present invention in water was measured as water has such an important presence within the gel network. The amount of water absorbed by each gel was calculated as a ratio of water absorbed by the gel (g), divided by the dry gel (g) over time.

The water swelling test by varying C % under constant T at 10% are shown in FIG. 3 and FIG. 4 respectively for both BIS and mBIS cross-linked polyacrylamide gels.

The swelling tests where C was kept at 3% (FIG. 3), show that for both BIS and mBIS gels, the water uptake decreased as T was increased. This was a reflection of the physical properties of the gels. Gels of low T % are soft and flexible, allowing them to swell and take up water. Gels of high T % are harder and brittle, not allowing as much swelling, so the gels take up little water. The decrease in water uptake as T % was increased was more dramatic in the mBIS gels than the BIS gels. The water uptake of the mBIS gels was higher than the water uptake of the BIS gels of equivalent concentrations. The difference in water uptake between the BIS and mBIS gels became larger as T was decreased.

Similarly the swelling tests of the gels with C=7% (FIG. 4) show that as T was increased the water uptake of the gels decreased. For T=5% the mBIS gel had a significantly higher water uptake than the BIS gel. However, for values of T greater than 10% the BIS and mBIS gels had similar water uptake. At high concentrations the gels water swelling properties appears to be a reflection of the hydrophobic nature of the monomers.

### Example 13

### Electrophoresis (PAGE)

Electrophoresis is an established technique for separating biomaterials by size and/or net electrical surface charge density where fractionation by size depends on the porosity of the gel network. The pore size and pore size distribution of different crosslinked polyacrylamide gels was indirectly related to the crosslinker by investigating and comparing the electrophoretic migration pattern of protein standards by size along the gel using the electrophoresis techniques SDS-PAGE.

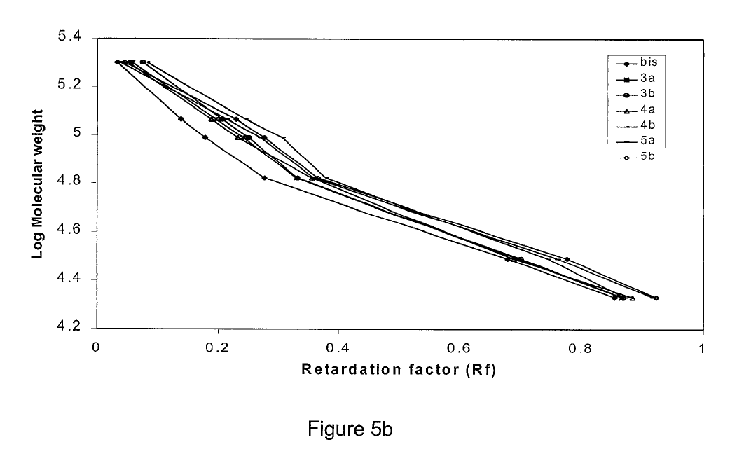

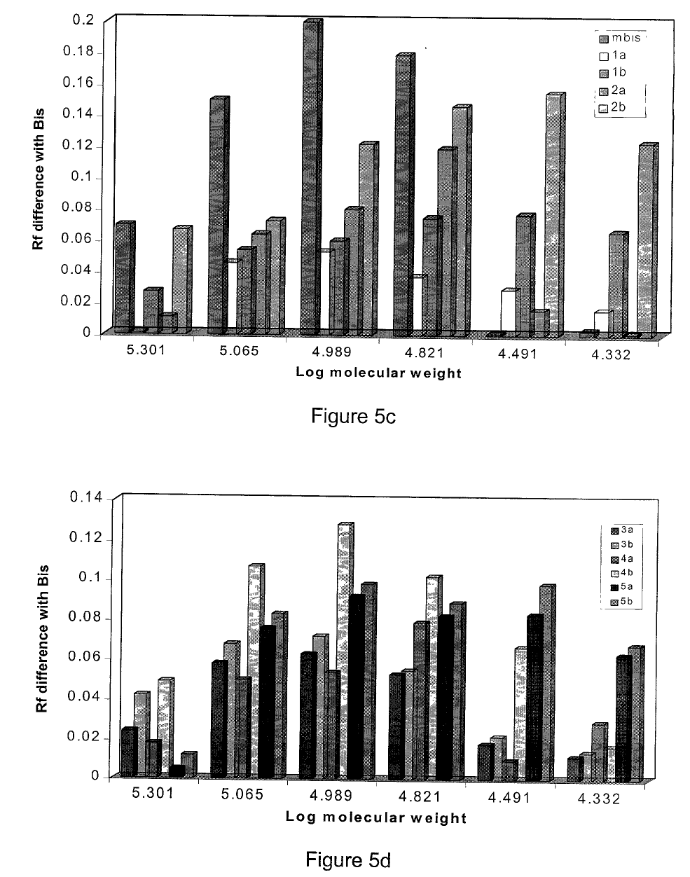

To correlate the crosslinker structural characteristics to the porosity of the gel, the Retardation factor (R_{f}), which is the distance migrated by each protein fraction divided by the distance traveled by the dye front, was calculated. FIG. 5a and FIG. 5b show Ferguson plots and the migration patterns obtained for the polyacrylamide gels containing different crosslinkers after fractionation by PAGE of a broad range protein standard. The Rf difference for each protein fraction separated on the new crosslinked gel compared to that of the standard BIS crosslinked gel was calculated and the results are shown in FIG. 5c and FIG. 5d. Maintaining a constant gel concentration of 10% T 3% C, polyacrylamide gels crosslinked with methacrylamide type reactive crosslinkers which have greater protein separation than their respective acrylamide type crosslinkers.

### Example 14

### Electrophoresis Comparison of BIS and mBIS Gels

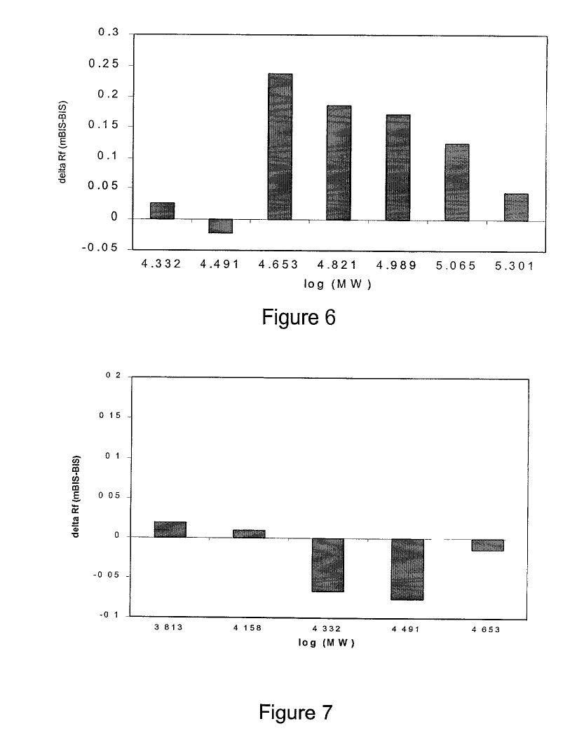

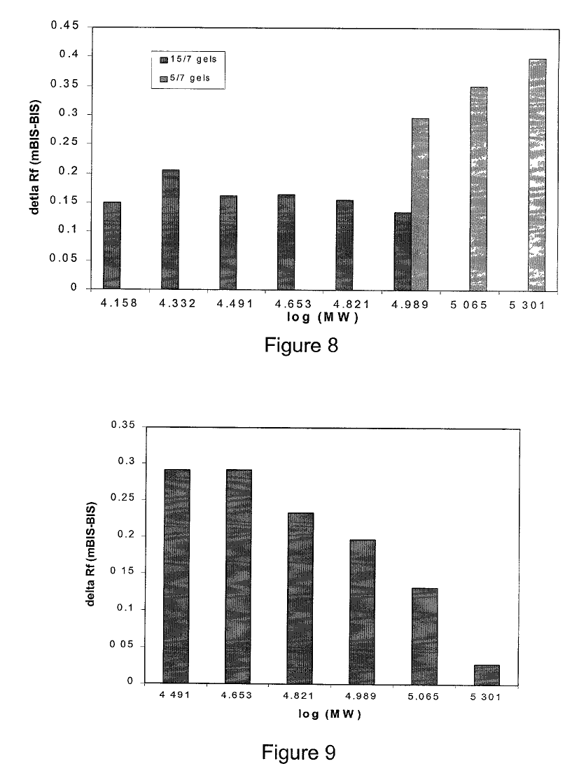

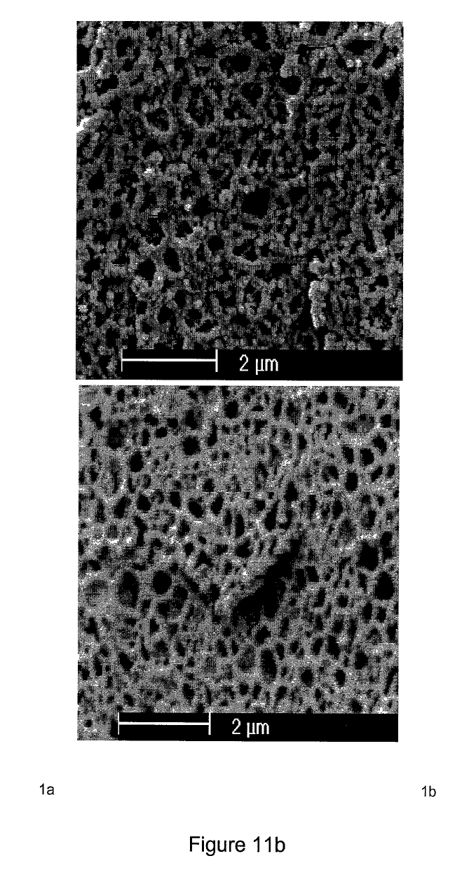

In addition, the difference between the R_{f} values of BIS and mBIS cross-linked polyacrylamide gels have been plotted for each of the protein bands that could be identified. A comparison between BIS and mBIS at a concentration of T=15% and C=3% is shown in FIG. 6 and FIG. 7. The protein bands appear to travel further through mBIS gels compared to BIS gels, except for the smaller proteins of log(MW)=4.491. The four bands between log(MW) 4.653 and 5.065 travel significantly further in mBIS than BIS. There appears to be little difference in the Rf values for the proteins of low molecular weight. For the T=15%, C=3% gels, the mBIS gel allows proteins (especially large proteins) to travel more easily through its gel network, suggesting there are larger pores in the gel structure. The water swelling tests back this up with the T=15%, C=3% mBIS gel having a much larger water uptake than the BIS gel, see FIG. 10.

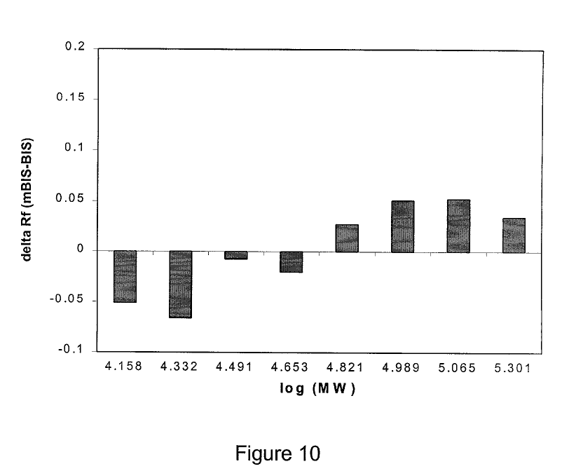

A comparison between T=5%, C=7% and T=15%, C=7% BIS and mBIS gels is shown in FIG. 8. The three protein bands detected for each gel concentration have greater R_{f} values in the mBIS gel than the BIS gels. This shows that the 5/7 mBIS gels will have a network with larger pore sizes than the 5/7 BIS gel. The swelling tests support this with the 5/7 mBIS gel having a greater water uptake than the 5/7 BIS gel. The electrophoresis shows that the 15/7 mBIS gel has larger pore size than the 15/7 BIS gel. This is contradictory to the swelling tests, which showed the 15/7 BIS, and mBIS gels to have the same water uptake, see FIGS. 11a and 11b.

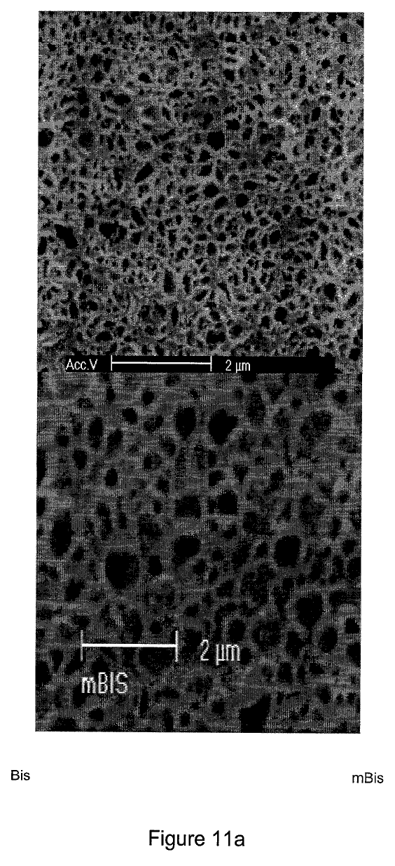

Electrophoresis was also performed on 10/5 and 20/5 BIS and mBIS gels, as can be seen in FIG. 9 and FIG. 10. The comparison of the 10/5 gels shows that the protein bands in mBIS have higher R_{f} values than in the BIS gel. However, the comparison of the 20/5 gels show that the two gels have fairly similar R_{f} values, where the mBIS gel has allowed the larger proteins to migrate further than the BIS gel, but the smaller proteins have migrated further in the BIS gel than the mBIS gel. This can be explained by the pore size distribution of mBIS compared to the relatively uniform structure of BIS gels. The small proteins travel relatively easily through the pores of BIS but the areas of the mBIS structure that are highly cross-linked and have small pores, hinder the migration of the proteins. The large proteins have difficulty moving through the BIS gel structure but the presence of areas with a looser matrix and little cross-linking in the mBIS structure allows for freer movement of these large proteins.

From these results it appears that the mBIS gels have a looser structure and slightly larger pores than the BIS gels. The greatest difference between the structures of the BIS and mBIS occurred at low T (T=5%). As T increased the difference between the structure of BIS and mBIS gels became less. When T reached 30%, there was very little difference between the pore structures of the gels cross-linked with BIS or mBIS.

Overall in this set of experiments, it was found that polyacrylamide gels cross-linked with mBIS have bigger pore sizes than polyacrylamide gels cross-linked with BIS with equivalent concentrations. The differences in pore sizes between mBIS and BIS gels of equivalent T % and C % concentrations, was found to be greatest when T % was small and the difference minimal when T % was larger. The pore size of the gel structure was found to decrease as either T % or C % increased. This was found to be true for polyacrylamide gels cross-linked with either BIS or mBIS.

### Example 15

### SEM Observations

Polyacrylamide gels crosslinked with BIS have been studied using SEM showing that a gel freeze dried at low temperatures could sublime the water from its pores whilst maintaining its structure without shrinking or introducing artifacts. However, a standard and very precise preparation method is needed for every gel compared, because the temperature and the time of water sublimation from the surface of the gel can alter the apparent pore sizes observed. The images taken of the gels crosslinked with BIS, mBis, 1a and 1b are shown in FIGS. 11a and 11b and clearly show a variation in the pore sizes and pore size distribution of each gel. The gels crosslinked with mBis and 1b appear to have a greater pore size distribution, where highly crosslinked areas have smaller pores surrounded by low crosslinked areas that have larger pores than Bis and 1a gels respectively.

### Example 16

### Preparation of Membrane from HEMA and EGDMA (36% T/3.6% C)

A 50 mL solution containing the monomer, hydroxyl ethyl methacrylate (HEMA) (17.3944 g) and the crosslinker ethylene glycol dimethacrylate (EGDMA) (0.6428 g) was degassed with argon until the oxygen level in the solution was below 3%. The solution was then transferred to a membrane-making tower (size 190×80×100 mm) followed by the addition of the initiator (10%) APS (0.25 mL) and the co-initiator TEMED (0.12 mL). Five membranes were then cast between glass plates where a non-wove PET substrate (pre-treated with 10% BL18 surfactant) was used as a support. The reaction was allowed to polymerize for at least 3 hours before the membrane was taken out. The membranes were washed with distilled water before used in Gradiflow® for protein separation.

### Example 17

### Preparation of Membrane from HEA and EGDMA (32.3% T/4% C)

A 50 mL mixture solution containing the monomer, hydroxyl ethyl acrylate (HEA) (15.5211) and the crosslinker, ethylene glycol dimethacrylate (EGDMA) (0.6429 g) was degassed with argon until the oxygen level in the solution was below 3%. The solution was then transferred to a membrane-making tower (size 190×80×100 mm) and initiated using the initiator (10%) APS (0.5 mL) and the co-initiator (10%)TEMED (0.24 mL). Five membranes were then cast between glass plates where a non-wove PET substrates (pre-treated with 10% BL18 surfactant) were used as support. The reaction was allowed for at least 3 hours before the membrane was taken out, washed with distilled water and used in Gradiflow® for protein separation.

### Example 18

### Preparation of Membrane from HEA and EGDA (31.8% T/2.4% C)

A 50 mL solution containing the monomer, hydroxyl ethyl acrylate (HEA) (15.5211) and the crosslinker, ethylene glycol diacrylate (EGDA) (0.5519 g) was degassed with argon until the oxygen level in the solution was below 3%. The solution was then transferred to a membrane-making tower (size 190×80×100 mm) and immediately initiated with the initiator (10%) APS (0.5 mL) and the co-initiator TEMED. (10%) (0.24 mL). Five membranes were then cast between glass plates where non-wove PET substrates (pre-treated with 10% BL18 surfactant) were used as support. The reaction was allowed for at least 3 hours before the membrane was taken out. The membranes were washed with distilled water before used in Gradiflow® for protein separation.

### Example 19

### Clarity Comparison Between HEMA/EGDMA and HEA/EGDMA Gels

Equivalent 50 mL monomer stock solutions, were prepared using the following formulations:

Stock solution 1 for HEMA/EGDMA gel: 17.3944 g HEMA and 0.6428 g EGDMA

Stock solution 1 For HEA/EGDMA gel: 15.5211 HEA and 0.6428 g EGDMA

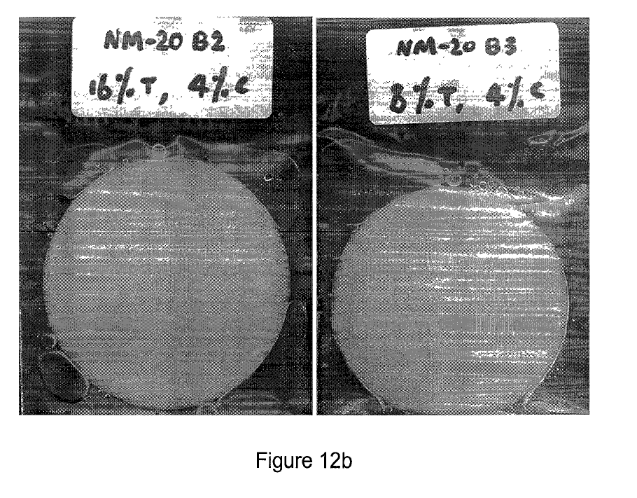

The stock solutions were diluted with water using the formulation below and degassed with Ar for 10 min. The gels were cast in Petri dishes (at 50 mm): under Ar blankets. Each of these samples were initiated with 0.2 mL of 10% APS and 0.096 mL TEMED and the solutions were left to polymerize. The clarity was observed and recorded by scanning. FIGS. 12a and 12b show the scanned gel, which demonstrate that under the same molarity (with equivalent amount double bonds), HEMA/EGDMA gels are opaque (sample 1 and 2) while HEA/EGDMA gels are more clear.

| | | | | |
|---|---|---|---|---|
| Sample 1: | 5 mL | solution 1, | 5 mL water | (18T %/3.6% C.) |
| Sample 2: | 2.5 mL | solution 1, | 7.5 mL water | (9%/3.6% C.) |
| Sample 3: | 5 mL | solution 2, | 5 mL water | (16T %/4% C.) |
| Sample 4: | 2.5 mL | solution 2, | 7.5 mL water | (8T%/3.6% C.) |

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A crosslinked polymer system comprised of:
at least one monomer having at least one double bond; and
at least one crosslinker having a plurality of functional groups, wherein the functional groups have a greater reactivity than the monomer.

2. The crosslinked polymer system according to claim 1 wherein reactivity ratio (r) of the at least one crosslinker to the at least one monomer for r₁ is in the range of about 0.001 to about 0.8 and for r₂ is in the range of about 1 to about 6.

3. The crosslinked polymer system according to claim 2 wherein the reactivity ratio (r) of the at least one crosslinker to the at least one monomer for r₁ is the range of about 0.05 to about 0.1 and for r₂ is in the range of about 1.3 to about 4.

4. The crosslinked polymer system according to claim 1 wherein % T of the polymer system is in the range of about 5% T to about 40% T and wherein % C is in the range of about 3% C to about 15% C.

5. The crosslinked polymer system according to claim 1 wherein the polymer system is a hydrogel.

6. The crosslinked polymer system according to claim 5 wherein the hydrogel has a hetero microphase structure gel network characterized by a plurality of highly crosslinked loci interconnected by relatively linear polymer chains.

7. The crosslinked polymer system according to claim 6 wherein the functional groups of the at least one crosslinker are all the same and wherein at least two of the functional groups are more reactive than the at least one double bond of the monomer.

8. The crosslinked polymer system according to claim 6 wherein at least two of the functional groups of the at least one crosslinker are different and wherein at least two of the functional groups are more reactive than the at least one double bond of the monomer.

9. The crosslinked polymer system according to claim 1 wherein the at least one crosslinker is selected from the group consisting of linear compounds, branched compounds, and cyclic compounds.

10. The crosslinked polymer system according to claim 1 wherein substantially all the functional groups of the at least one crosslinker have an ethylenic double bond.

11. The crosslinked polymer system according to claim 1 wherein the at least one monomer has the formula H₂C═CR₅—CO—N(R₃)R₄ where R₃ and R₄ are each selected from the group consisting of H, alkyl, alcohol (—(CH₂)ₙ—OH), and ester (—(CH₂)ₙ—OCH₃), where n is an integer from 1 to 6, and where R₅ is selected from the group consisting of H and substituted alkyl.

12. The crosslinked polymer system according to claim 11 wherein the at least one monomer is selected from the group consisting of acrylamide, acrylamide derivatives, acrylamide substitutes, and mixtures thereof.

13. The crosslinked polymer system according to claim 12 wherein the at least one monomer is selected from the group consisting of N,N-dimethylacrylamide, methacrylamide, N-methyloylacrylamide, propylacrylamide, dipropyl acrylamide, isopropyl acrylamide, diisopropyl acrylamide, lactyl acrylamide, methoxyacrylamide, and mixtures thereof.

14. The crosslinked polymer system according to claim 13 comprised of a monomer system of acrylamide with methylenebismethylacrylamide.

15. The crosslinked polymer system according to claim 13 comprised of a monomer system of acrylamide with 2-hydroxyethyl methacrylate.

16. The crosslinked polymer system according to claim 1 comprised of non-acrylamide type monomers comprising ester type systems.

17. The crosslinked polymer system according to claim 16 wherein the ester type system is comprised of hydroxyethyl acrylate which functions as the at least one monomer and ethyleneglycol dimethacrylate which functions as the at least one crosslinker.

18. The crosslinked polymer system according to claim 16 wherein the ester type system is selected from the group consisting of:

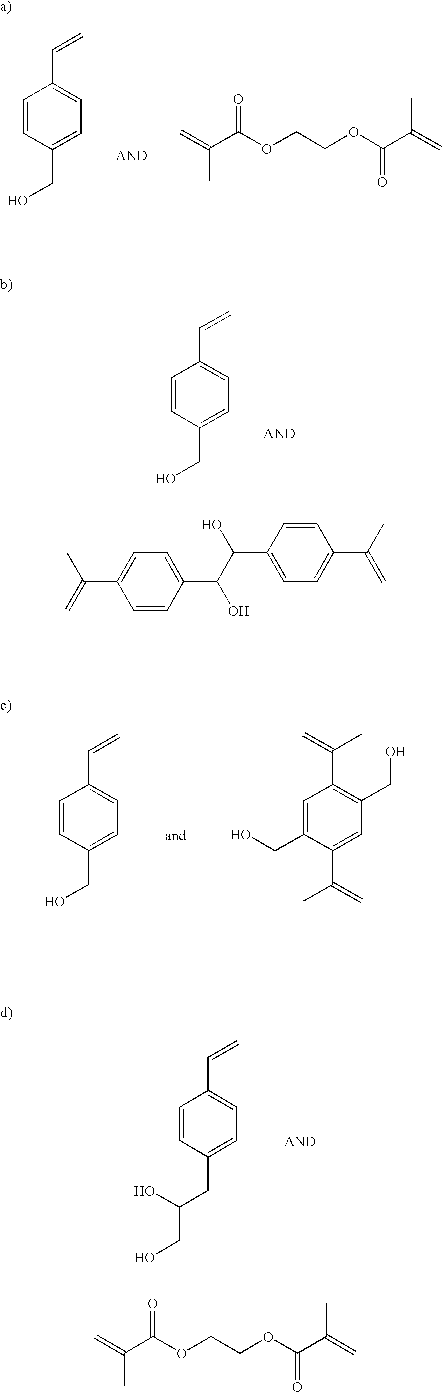

19. The crosslinked polymer system according to claim 1 wherein such system has high optical clarity.

20. An article comprised of a crosslinked polymer system, the crosslinked polymer system comprising at least one monomer having at least one double bond and at least one crosslinker having a plurality of functional groups, wherein the functional groups have a greater reactivity than the monomer.

21. The article according to claim 20 wherein the article is an optical lens.

22. The article according to claim 21 wherein the article is a contact lens.

23. The article according to claim 20 wherein the article is an electrophoresis gel.

24. The article according to claim 23 wherein the electrophoresis gel has a select one of porosity gradient, a composition gradient, and a concentration gradient.

25. The article according to claim 24 wherein the gradient of the electrophoresis gel is achieved by a select one of using different concentrations of the polymer gel and altering the ratio of crosslinker to monomer.

26. The article according to claim 20 wherein the article comprises a membrane formed on a porous substrate.

27. The article according to claim 26 wherein the porous substrate is selected from the group consisting of paper, fabric, woven sheet, and non-woven sheet.

28. A method for forming a crosslinked polymer system comprising the steps of:
preparing a crosslinker solution comprised of at least one crosslinker;
preparing a monomer solution comprised of at least one monomer; wherein the at least one crosslinker in the crosslinker solution must have a greater reactivity then the at least one monomer in the monomer solution;
mixing the crosslinker solution and the monomer solution together to form a crosslinker/monomer solution;
preparing an initiator solution comprised of a polymerization initiating material which initiates polymerization of the crosslinker/monomer solution;
mixing the crosslinker/monomer solution and the initiator solution together to form an initiated solution; and
allowing the initiated solution is allowed to polymerize to form the crosslinked polymer system.

29. The method according to claim 28 wherein reactivity ratio (r) of the at least one crosslinker to the at least one monomer for r₁ is in the range of about 0.001 to about 0.8 and for r₂ is in the range of about 1 to about 6.

30. The method according to claim 29 wherein the reactivity ratio (r) of the at least one crosslinker to the at least one monomer for r₁ is the range of about 0.05 to about 0.1 and for r₂ is in the range of about 1.3 to about 4.

31. The method according to claim 28 wherein % T of the polymer system is in the range of about 5% T to about 40% T and wherein % C is in the range of about 3% C to about 15% C.

32. The method according to claim 28 wherein the polymer system is a hydrogel.

33. The method according to claim 32 wherein the hydrogel has a hetero microphase structure gel network characterized by a plurality of highly crosslinked loci interconnected by relatively linear polymer chains.

34. The method according to claim 33 wherein the functional groups of the at least one crosslinker are all the same and wherein at least two of the functional groups are more reactive than the at least one double bond of the monomer.

35. The method according to claim 33 wherein at least two of the functional groups of the at least one crosslinker are different and wherein at least two of the functional groups are more reactive than the at least one double bond of the monomer.

36. The method according to claim 28 wherein the at least one crosslinker is selected from the group consisting of linear compounds, branched compounds, and cyclic compounds.

37. The method according to claim 28 wherein substantially all the functional groups of the at least one crosslinker have an ethylenic double bond.

38. The method according to claim 28 wherein the at least one monomer has the formula H₂C═CR₅—CO—N(R₃)R₄ where R₃ and R₄ are each selected from the group consisting of H, alkyl, alcohol (—(CH₂)ₙ—OH), and ester (—(CH₂)ₙ—OCH₃), where n is an integer from 1 to 6, and where R₅ is selected from the group consisting of H and substituted alkyl.

39. The method according to claim 38 wherein the at least one monomer is selected from the group consisting of acrylamide, acrylamide derivatives, acrylamide substitutes, and mixtures thereof.

40. The method according to claim 39 wherein the at least one monomer is selected from the group consisting of N,N-dimethylacrylamide, methacrylamide, N-methyloylacrylamide, propylacrylamide, dipropyl acrylamide, isopropyl acrylamide, diisopropyl acrylamide, lactyl acrylamide, methoxyacrylamide, and mixtures thereof.

41. The method according to claim 40 comprised of a monomer system of acrylamide with methylenebismethylacrylamide.

42. The method according to claim 40 comprised of a monomer system of acrylamide with 2-hydroxyethyl methacrylate.

43. The method according to claim 28 comprised of non-acrylamide type monomers comprising ester type systems.

44. The method according to claim 43 wherein the ester type system is comprised of hydroxyethyl acrylate which functions as the at least one monomer and ethyleneglycol dimethacrylate which functions as the at least one crosslinker.

45. The method according to claim 43 wherein the ester type system is selected from the group consisting of:

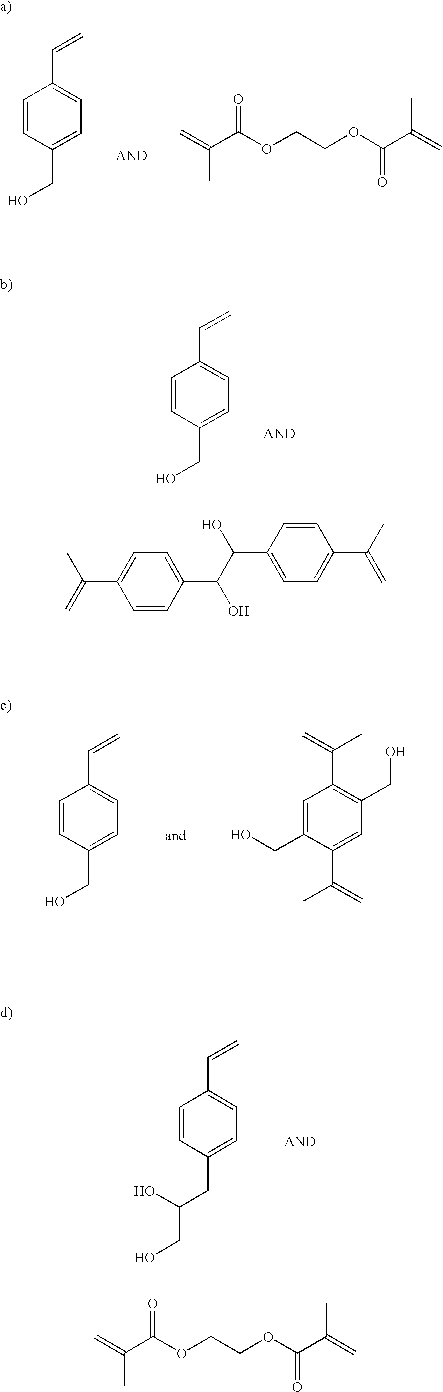

46. The method according to claim 28 wherein such system has high optical clarity.
